(19) United States
(12) Patent Application Publication
(10) Pub. No.: US 2010/0117828 A1
(43) Pub. Date: May 13, 2010

(54) Alarm scheme with olfactory alerting component

(76) Inventors: Stuart Owen Goldman, Scottsdale, AZ (US); Richard E. Krock, Naperville, IL (US); Karl F. Rauscher, Emmaus, PA (US); Carlos Curtis Solari, Shenandoah, VA (US)

Correspondence Address: Lucent Technologies Inc.;Docket Administrator - Room 2F-192, 600-700 Mountain Ave., Murray Hill, NJ, 07974-0636, US

(21) Appl. No.: 12/291,296

(22) Filed: Nov. 7, 2008

(51) Int. Cl. G08B 21/00

(52) U.S. Cl. 340/540

(57) ABSTRACT

An alarm system integrating the sense of smell (i.e., an olfactory component) as an alerting modality is described. The olfactory component is uniquely recognizable and distinguishable from traditional visual or audible alerting components and can be used to increase the number of separate alarms that a person can respond to and/or decrease the reaction time for responding to the alarms.

### FIELD OF THE INVENTION

This invention relates generally to alarm systems and, more particularly, to alarm systems integrating the sense of smell as an alerting modality.

### BACKGROUND OF THE INVENTION

Visual and audible alarm modalities (e.g., lights, colors, tones, horns, etc.) are well known alerting mechanisms for informing persons of certain events or prospective events, including, without limitation, adverse events that can be harmful to persons or property. Generally, the greater number and complexity of prospective events that may occur in an alarm environment will equate to greater numbers and different types of alarm modalities; and potentially, multiple simultaneous alerts. Advantageously, responsive to such alert(s), a responsible person or persons will recognize the type of event(s) corresponding to the alarm and will take action to prevent or minimize undesirable consequences of the event(s). However, most particularly when presented with multiple simultaneous alerts, there is a potential that responsible persons will become overwhelmed or desensitized to the alerts, leading to recognition and procedural errors that can create a risk of harm to persons or property. In view of this problem, there is a continuing need to develop alarm modalities having alerting components that are uniquely recognizable and distinguishable from traditional visual and audible alarm modalities. Advantageously, the new alarm modalities will increase the number of separate alarms that a responsible person can recognize and respond to without overwhelming or desensitizing the senses of sight and hearing associated with traditional alarm modalities.

### SUMMARY OF THE INVENTION

The present invention provides alarm schemes integrating the sense of smell (i.e., an olfactory component) as an alerting modality. The olfactory component is uniquely recognizable and distinguishable from traditional visual or audible alerting components and can be used to increase the number of separate alarms that a person can respond to and/or decrease the reaction time for responding to the alarms.

In one embodiment, there is provided a method of implementing an alarm system comprising detecting an alerting event; and responsive to detecting the alerting event, releasing an aroma adapted to provoke a response to the alerting event. In one embodiment, the aroma is adapted to provoke a response by a person detecting the aroma. The response may be undertaken responsive to the person recognizing the aroma as corresponding to the alerting event, as a conditioned response or as a reflexive response.

In another embodiment, there is provided a method of implementing an alarm system comprising deploying one or more olfactory alarm components, detecting an alerting event; and responsive to detecting the alerting event, activating a designated one or more of the olfactory alarm components to produce an aroma adapted to provoke a response to the alerting event by a person detecting the aroma.

In another embodiment, there is provided an alarm system comprising a controller and one or more olfactory alarm components. The controller is operable responsive to detecting an alerting event to activate a designated one or more of the olfactory alarm components to produce an aroma that is adapted to provoke a response to the alerting event by a person detecting the aroma.

### BRIEF DESCRIPTION OF THE DRAWINGS

The foregoing and other advantages of the invention will become apparent upon reading the following detailed description and upon reference to the drawings in which:

FIG. 1 is a block diagram of a prior art alarm scheme having visual and audible alarm modalities;

FIG. 2 is a block diagram of an alarm scheme having an olfactory alarm component according to embodiments of the invention; and

FIG. 3 is a flowchart of a method for implementing an alarm scheme having an olfactory alarm component according to embodiments of the invention.

### DESCRIPTION OF THE PREFERRED EMBODIMENT(S)

FIG. 1 is a block diagram of a traditional alarm system 100 having visual and alarm modalities. A controller 102 monitors an environment for the occurrence of prospective events (event₁ . . . eventₙ) comprising, generally, any condition or state of a monitored space or item that is desired to trigger an alarm and in turn, to trigger recognition and action by a responsible person to prevent or minimize undesirable consequences of the event(s). For example, the events may be associated with unsafe operating thresholds of machinery, electronic components or the like; or in the context of a residential alarm system, the events may be associated with home intrusion, fire, carbon monoxide or flood detection.

The controller 102 may communicate with remote sensors (not shown) for detecting the prospective events; alternatively or additionally, the controller 102 may itself include sensors for detecting prospective events. Upon occurrence of an event, the controller 102 triggers operation of one or more audible alarms 104 and/or visual alarms 106 corresponding to the event such that persons in the vicinity of the alarms will become alerted to the event and take action, as may be appropriate, to respond to the event. As is well known, the alarms 104, 106 may comprise, for example, lights, colors, tones, horns, etc. The alarms 104, 106 may be local or remote to the controller 102.

Depending on complexity of the alarm system 100, the controller 102 may operate to execute multiple simultaneous alarms corresponding to multiple events. As has been noted, the presence of multiple simultaneous alarms can become overwhelming to persons in the vicinity of the alarms leading to potential recognition and procedural errors that can create a risk of harm to persons or property.

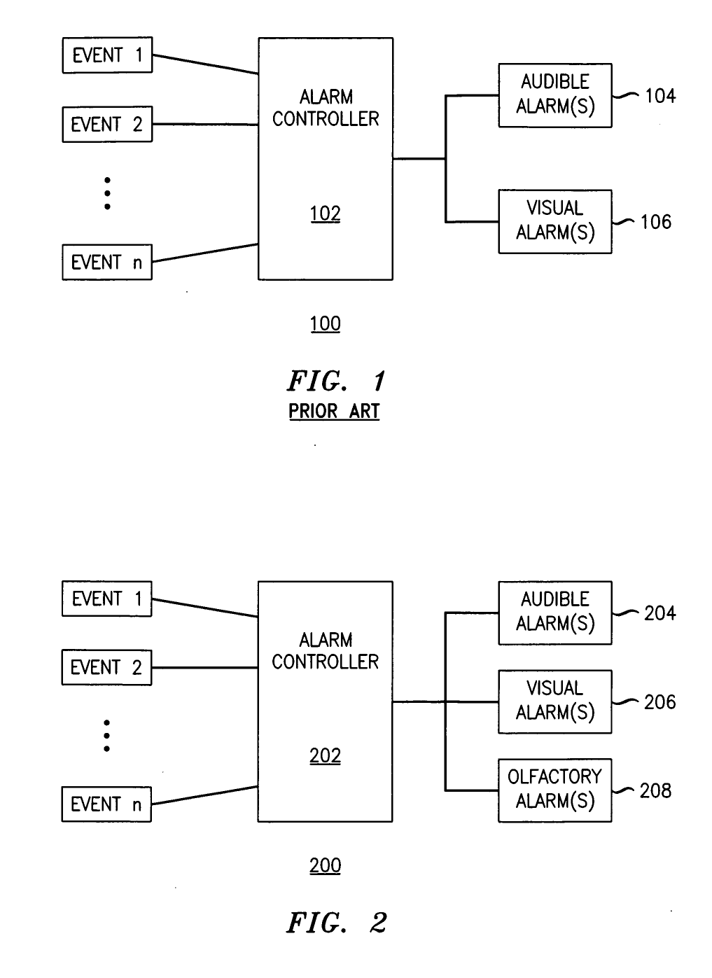

Referring to FIG. 2, an alarm system 200 integrating the sense of smell (i.e., an olfactory component) as an alerting modality is shown. A controller 202 monitors an environment for the occurrence of prospective events (event₁ . . . eventₙ) comprising, generally, any condition or state of a monitored space or item that is desired to trigger an alarm and in turn, to trigger recognition and action by a responsible person to prevent or minimize undesirable consequences of the event(s) such as described in relation to FIG. 1.

The controller 202 may communicate with remote sensors (not shown) for detecting the prospective events; alternatively or additionally, the controller 202 may itself include sensors for detecting prospective events. Upon occurrence of an event, the controller 202 triggers operation of one or more audible alarms 204, visual alarms 206 or olfactory alarms 208 corresponding to the event such that persons in the vicinity of the alarms will become alerted to the event and take action, as may be appropriate, to respond to the event. The alarms 204, 206, 208 may be local or remote to the controller 202.

The audible and visual alarms 204, 206 may comprise, for example, lights, colors, tones, horns, etc. In one embodiment, the olfactory alarms 208 comprise any substance or combination of substances that can be released, dispensed, transformed (e.g., burned or heated) or manipulated in some manner to produce a discernible odor corresponding to an event; and in turn, to trigger recognition and action by a responsible person to prevent or minimize undesirable consequences of the event.

The olfactory alarms 208 may be used independently or in conduction with the audible or visual alarms 204, 206 to alert persons to particular events. Depending on implementation, the olfactory alarms 208 may comprise multiple olfactory alarm components corresponding to multiple prospective events. Advantageously, the olfactory alarm components are uniquely recognizable and distinguishable from each other and of course, distinguishable from traditional visual or audible alerting components.

By way of example and not limitation, hydrogen sulfide, methyl mercaptan, methyl benzoate and dimethyl sulfide are chemical substances that may released, dispensed, transformed or manipulated in some manner to produce distinguishable odors for use as olfactory alarms 208. The chemicals may be used alone or in combination and may be metered in variable amounts to vary the intensity of the odors and hence produce further variation in distinguishable scents. The exact metering is quite dependent on the specific apparatus used to dispense the chemicals, but ranges of 1 to 5 percent mixture with the ambient air generally should produce sufficient stimulation and recognition without detrimental effects.

As will be appreciated, virtually any functional apparatus known or devised in the future may be used for releasing, dispensing, transforming or manipulating the olfactory substances. As an illustrative example without limitation, the apparatus may comprise a solenoid operating a valve of a canister to release a controlled supply or burst of aromatic gas or chemicals in the vicinity of a responsible person.

The use of olfactory components can be used to increase the number of separate alarms that a person can respond to at any given instant relative to that which would be possible using only audible and visual alarms. Further, it is contemplated that olfactory alarm components can be recognized more quickly and can invoke a quicker response than possible using only audible and visual alarms. We know that certain smells from specific foods or perfume can invoke very vivid memories or feelings. It follows that a person may be conditioned to respond more forcefully to a warning odor than possible with warning lights or sounds. Avery Gilbert in his recent book, “What the Nose Knows (the Science of Scent in Everyday Life)” suggests that the human brain's reaction to a pungent odor may in fact be faster than that of responding to visual or audible stimuli because it uses a more primitive portion of the brain. If a responsible person can be trained to have a conditioned reflex in response to a particular odor, the person may start the desired response even before the person is consciously aware of the odor.

The number of distinct odors detectable by the human nose is generally believed to be in the tens of thousands. Primary odors may be classified as camphoraceous, musky, floral, pepperminty, ethereal, pungent and putrid. It is a matter of implementation and training to select particular types of odors for use as olfactory alarms 208 and to associate them with particular events. As illustrative examples, an olfactory alarm may be used to warn an airplane pilot that he is running low on oxygen; or to warn a scuba diver that he is running low on compressed breathing gas. Still further, olfactory alarm components may be utilized to warn persons entering a biohazard area without a protective suit (or with a protective suit that is inoperable or incorrectly secured), for example, if the person can smell a designated pungent aroma, he is NOT protected from the potential biohazard. Such a warning would be difficult to ignore. Still another application might be the release of a coffee odor when the responsible person is detected to have become drowsy. Recent studies have shown a positive effect from a coffee aroma even in the absence of caffeine.

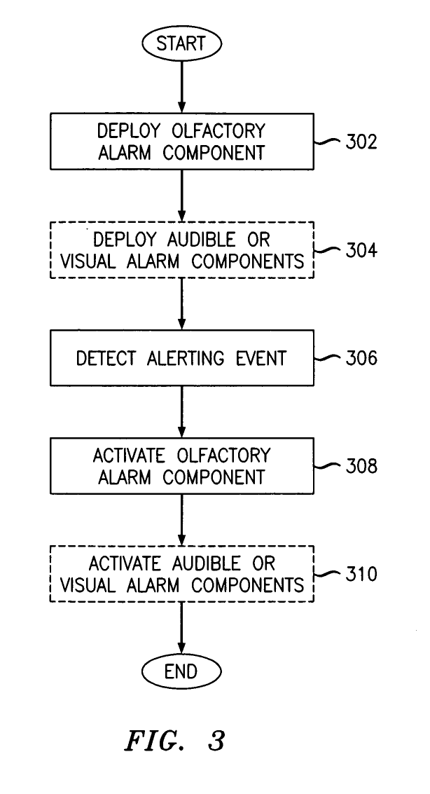

Now turning to FIG. 3, there is shown a flowchart for implementing an alarm system including one or more olfactory alarm components.

At step 302, an authority or agency responsible for implementing an alarm system deploys an olfactory alarm component (or optionally, multiple olfactory alarm components) corresponding to an event (or events). Advantageously, the olfactory alarm component is such that when activated, it will provoke a response to the event by a person detecting the aroma. For example, the response may be undertaken responsive to the person recognizing the aroma as corresponding to the alerting event, where the person has been trained to develop recognition of the olfactory component and to produce a conditioned response or desired response. Alternatively, the response may be undertaken as a reflexive response by a person or entity without any specific training (such as the exemplary application of a coffee aroma to counteract drowsiness).

Optionally, at step 304, the authority or agency responsible for implementing an alarm system may deploy audible or visual alarm components corresponding to an event or events. If deployed, the audible or visual alarm components may be adapted for operation in combination with an olfactory alarm component to provoke a response to the alerting event.

At step 306, a controller (or sensor, in communication with a controller) associated with the alarm system detects an alerting event, i.e., a condition or state of a monitored space or item that is desired to trigger an alarm. Responsive to detecting the alerting event, the controller activates the olfactory alarm component to release an aroma adapted to provoke a response to the event by a person. As noted in relation to step 302, the response may be undertaken responsive to the person recognizing the aroma as corresponding to the alerting event, where the person has been trained to develop recognition of the olfactory component and to produce a conditioned response or desired response to prevent or minimize undesirable consequences of the event. Alternatively, the response may be undertaken as a reflexive response by a person without any specific training.

Optionally, at step 308, the controller may activate audible or visual alarm components in combination with the olfactory alarm component to trigger recognition of the event and either a conditioned reflex or recognition and action by the responsible person to prevent or minimize undesirable consequences of the event.

The present invention may be embodied in other specific forms without departing from its spirit or essential characteristics. The described embodiments are to be considered in all respects only as illustrative and not restrictive. For example, the olfactory alarm components may be implemented with or without an alarm controller 202; and the olfactory alarm components may have physical characteristics or may produce characteristic odors that differ from the exemplary embodiments. The olfactory alarm components may be adapted to provoke a response by plants, animals or mechanical monitoring entities as an alternative or supplementary to human persons. The scope of the invention is, therefore, indicated by the appended claims rather than by the foregoing description. All changes that come within the meaning and range of equivalency of the claims are to be embraced within their scope.

What is claimed is:

1. A method of implementing an alarm system comprising:
detecting an alerting event; and
responsive to detecting the alerting event, releasing an aroma adapted to provoke a response to the alerting event.

2. The method of claim 1, wherein the aroma is adapted to provoke a response by a person detecting the aroma.

3. The method of claim 2, wherein the aroma is adapted to provoke a response by a person recognizing the aroma as corresponding to the alerting event.

4. The method of claim 2, wherein the aroma is adapted to provoke a conditioned response by the person detecting the aroma.

5. The method of claim 2, wherein the aroma is adapted to provoke a reflexive response by the person detecting the aroma.

6. The method of claim 2, wherein the step of releasing an aroma comprises releasing one or more chemical substances in the vicinity of the person.

7. The method of claim 2, wherein the step of releasing an aroma comprises releasing a mixture of two or more chemical substances in the vicinity of the person.

8. The method of claim 2, wherein the step of releasing an aroma comprises transforming a substance to produce an odor in the vicinity of the person.

9. A method of implementing an alarm system comprising:
deploying one or more olfactory alarm components;
detecting an alerting event; and
responsive to detecting the alerting event, activating a designated one or more of the olfactory alarm components to produce an aroma adapted to provoke a response to the alerting event by a person detecting the aroma.

10. The method of claim 9, further comprising deploying a visual alarm component; and
responsive to detecting the alerting event, activating the designated one or more of the olfactory alarm components in combination with the visual alarm component to provoke a response to the alerting event.

11. The method of claim 9, further comprising deploying an audible alarm component; and
responsive to detecting the alerting event, activating the designated one or more of the olfactory alarm components in combination with the audible alarm component to provoke a response to the alerting event.

12. An alarm system comprising:
a controller; and
one or more olfactory alarm components, the controller operable responsive to detecting an alerting event to activate a designated one or more of the olfactory alarm components to produce an aroma that is adapted to provoke a response to the alerting event by a person detecting the aroma.

13. The alarm system of claim 12, wherein the aroma is adapted to provoke a response by the person recognizing the aroma as corresponding to the alerting event.

14. The alarm system of claim 12, wherein the designated olfactory alarm components are adapted to release one or more chemical substances in the vicinity of the person when activated by the controller.

15. The alarm system of claim 12, wherein the designated olfactory alarm components are adapted to transform a substance to produce an odor in the vicinity of the person when activated by the controller.
